(19) United States
(12) Patent Application Publication
(10) Pub. No.: US 2007/0243400 A1
(43) Pub. Date: Oct. 18, 2007

(54) Method for Producing Composite Soft Magnetic Material Exhibiting Excellent Magnetic Characteristics, High Strength and Low Core Loss

(75) Inventors: Masahisa Miyahara, Niigata-shi (JP); Koichiro Morimoto, Niigata-shi (JP)

Correspondence Address: DARBY & DARBY P.C., P.O. BOX 770, Church Street Station, New York, NY, 10008-0770, US

(73) Assignee: Mitsubishi Materials PMG Corporation, Niigata-shi, Nagata (JP)

(21) Appl. No.: 10/595,591

(22) PCT Filed: Oct. 28, 2004
(86) PCT No.: PCT/JP04/15984

§ 371 Date: Jan. 30, 2007

(30) Foreign Application Priority Data
Oct. 31, 2003 (JP) 2003-371993

(51) Int. Cl. B22F 1/02; H01F 1/26; H01F 41/02

(52) U.S. Cl. 428/546; 264/80

(57) ABSTRACT

A method of manufacturing a composite soft magnetic material having excellent magnetic characteristics, a high strength, and a low core loss, having steps of: heating a silicon resin film-coated soft magnetic powder at a temperature of from the room temperature to 150° C. obtained by forming a thin silicon resin film having a thickness of from 0.1 μm to 5 μm on a surface of a soft magnetic powder or an insulating film-coated soft magnetic powder; filling the silicon resin film-coated soft magnetic powder at a temperature of from the room temperature to 150° C. in a mold which is heated at a temperature of from 100° C. to 150° C. and performing compaction at a pressure of from 600 MPa to 1500 MPa, thereby obtaining a compact; and curing the compact at a temperature of from 400° C. to 600° C.

### CROSS-REFERENCE TO PRIOR APPLICATION

This is a U.S. National Phase Application under 35 U.S.C. §371 of International Patent Application No. PCT/JP2004/015984, filed Oct. 28, 2004, and claims the benefit of Japanese Patent Application No. 2003-371993, filed Oct. 31, 2003, both of which are incorporated by reference herein. The International Application was published in Japanese on May 12, 2005 as International Publication No. WO 2005/043560 under PCT Article 21(2).

### TECHNICAL FIELD

The present invention relates to a method for producing a composite soft magnetic material exhibiting excellent magnetic characteristics, high strength, and low core loss. The method of manufacturing the complex soft magnetic material is used to manufacture an injector part, an ignition part, an electronic valve core, and a motor core.

### BACKGROUND ART

In general, as soft magnetic powder, there is known iron powder, Fe—Si iron-based soft magnetic alloy powder, Fe—Al iron-based soft magnetic alloy powder, Fe—Si—Al iron-based soft magnetic alloy powder, Fe—Cr iron-based soft magnetic alloy powder, Ni-based soft magnetic alloy powder, or Fe—Co soft magnetic alloy powder. The iron powder includes pure iron powder, the Fe—Si iron-based soft magnetic alloy powder includes Fe—Si iron-based soft magnetic alloy powder containing 0.1-10 wt % of Si and the balance composed of Fe and necessary impurities (for example, ferrosilicon powder containing 1-12 wt % of Si and the balance composed of Fe and necessary impurities, more particularly, Fe-3% Si powder), the Fe—Al iron-based soft magnetic alloy powder includes Fe—Al iron-based soft magnetic alloy powder containing 0.05-10 wt % of Al and the balance composed of Fe and necessary impurities (for example, Alperm powder having a composition of Fe-15% Al), the Fe—Si—Al iron-based soft magnetic alloy powder includes Fe—Si—Al iron-based soft magnetic alloy powder containing 0.1-10 wt % of Si, 0.05-10 wt % of Al and the balance composed of Fe and necessary impurities (for example, Sendust powder having a composition of Fe-9% Si-5% Al), the Fe—Cr iron-based soft magnetic alloy powder includes Fe—Cr iron-based soft magnetic alloy powder containing 1-20% of Cr, if necessary, one or two of 5% or less of Al and 5% or less of Si, and the balance composed of Fe and necessary impurities, the Ni-based soft magnetic alloy powder includes Ni-based soft magnetic alloy powder containing 35-85% of Ni, if necessary, one or two of 5% or less of Mo, 5% or less of Cu, 2% or less of Cr, and 0.5% or less of Mn, and the balance composed of Fe necessary impurities (for example, Fe-79% Ni powder), and the Fe—Co soft magnetic alloy powder includes Fe—Co iron-based alloy powder 10-60% of Co, if necessary, 0.1-3% of V, and the balance composed of Fe and necessary impurities. (% means wt % for above)

As a soft magnetic powder (hereinafter, referred to as an insulating film-coated soft magnetic powder) of which surface is coated with an insulating film, there are known oxide film-coated soft magnetic powder formed by performing high-temperature oxidation treatment on the soft magnetic powder to form an oxide film on the surface thereof, phosphate film-coated soft magnetic powder formed by performing phosphate treatment on the soft magnetic material to form a phosphate film on the surface thereof, and hydroxylation film-coated soft magnetic powder formed by performing steam treatment on the soft magnetic powder to form an insulating hydroxylation film on the surface thereof. Among these insulating film-coated soft magnetic powders, phosphate film-coated soft magnetic powder obtained by forming a phosphate film on the surface of pure iron powder is generally used.

In order to increase a filling density thereof, the insulating film-coated soft magnetic powder is compression-molded together with a binder at a pressure as high as possible. However, in the composite soft magnetic material obtained by high pressure compression molding, compression deformation occurs in the soft magnetic powder within the insulating film-coated soft magnetic powder during the compression molding, and the soft magnetic characteristics thereof deteriorate, so that it is difficult to obtain sufficient characteristics of the material. For the reason, the composite soft magnetic material obtained by the compression is thermally treated to remove the deformation, so that the soft magnetic characteristics are recovered.

In order to remove the deformation of the soft magnetic powder, it is preferable that the soft magnetic powder is heated at a temperature of 500° C. or more. However, if the composite soft magnetic material is heated at the temperature, the composite soft magnetic material which is formed by using as a binder a thermo plastic resin such as a polyphenylether resin, and polyetherimide resin or a thermo setting resin such as a phenol resin, an epoxy region, and an organic resin is carbonized or burned. For the reason, a composite soft magnetic material formed by using as a binder a water glass has been proposed (see Japanese Unexamined Patent Application Publication No. Sowha 56-155510). Sine the composite soft magnetic material with the water glass as a binder has a strength lower than that of a composite soft magnetic material with the organic resin as a binder and absorbs moisture to be softened, the composite soft magnetic material with the water glass as a binder has a low durability. Therefore, recently, a composite soft magnetic material with a silicon resin as a binder has been proposed. The composite soft magnetic material with a silicon resin as a binder is manufactured by heating a soft magnetic powder in an oxidation ambience at a temperature of from 250 (C to 950 (C to form an oxidation film, that is, an insulating film on a surface thereof to produce an insulating film-coated soft magnetic powder, adding and mixing a 0.5-10 wt % of a silicon resin to the insulating film-coated soft magnetic powder, performing compression molding thereon, and performing curing thereon in a non-oxidation ambience at a temperature of from 500 (C to 1000 (C to remove a deformation thereof (see Japanese Unexamined patent Application Publication No. Heisei 6-342714).

### DISCLOSURE OF THE INVENTION

According to the conventional method, a 0.5-10 wt % of the silicon resin needs to be added, and as the additive amount of the silicon resin increases, the additive amount of the insulating film-coated soft magnetic powder decreases. Therefore, the magnetic characteristics of the composite magnetic material deteriorate. On the contrary, when the additive amount of the silicon resin is less than 0.5 wt %, the strength and specific resistance thereof deteriorate, so that it is not preferred. For the reason, there is a need to develop a composite soft magnetic material capable of increasing an amount of the insulating film-coated soft magnetic powder and sustaining a high strength and a low core loss by reducing the additive amount of the silicon resin as low as possible.

The inventors researched manufacturing of a composite soft magnetic material capable of improving magnetic characteristics thereof and sustaining a high strength and a low core loss by further decreasing an amount of a silicon resin and further increasing an amount of a soft powder or an insulating film-coated soft magnetic powder.

As a result of the research, a silicon resin film-coated soft magnetic powder is produced by forming a thin silicon resin film having a thickness of from 0.1 (m to 5 (m on a surface of a soft magnetic powder or an insulating film-coated soft magnetic powder. The silicon resin film-coated soft magnetic powder is heated at a temperature of from the room temperature to 150 (C in advance. The silicon resin film-coated soft magnetic powder heated at a temperature of from the room temperature to 150 (C is filled in a mold which is heated at a temperature of from 100 (C to 150 (C and is subject to compression molding at a pressure of from 600 MPa to 1500 MPa, thereby obtaining a compact. The compact is subject to curing at a temperature of from 400 (C to 600 (C, thereby a composite soft magnetic material. In the composite soft magnetic material, the soft magnetic powder is closely coated with the silicon resin, and even though the additive amount of the silicon resin is suppressed to be less that 0.5 wt %, the composite soft magnetic material can have the high strength and low core loss that are substantially the same as those of a composite soft magnetic material manufactured according to conventional methods. In addition, since an amount of the soft magnetic powder increases, the magnetic characteristics are further improved.

In addition, as a result of the research, the insulating film-coated soft magnetic powder is more preferably a phosphate film-coated soft magnetic powder with a phosphate film coated on a surface thereof.

The present invention is contrived based on the results of the research.

According to an aspect of the present invention, there is provided a method of manufacturing a composite soft magnetic material having excellent magnetic characteristics, a high strength, and a low core loss, having steps of: heating a silicon resin film-coated soft magnetic powder at a temperature of from the room temperature to 150 (C obtained by forming a thin silicon resin film having a thickness of from 0.1 (m to 5 (m on a surface of a soft magnetic powder or an insulating film-coated soft magnetic powder; filling the silicon resin film-coated soft magnetic powder heated at a temperature of from the room temperature to 150° C. in a mold which is heated at a temperature of from 100° C. to 150° C. and performing compaction at a pressure of from 600 MPa to 1500 MPa, thereby obtaining a compact; and curing the compact at a temperature of from 400° C. to 600° C.

According to another aspect of the present invention, there is provided a method of manufacturing a composite soft magnetic material having excellent magnetic characteristics, a high strength, and a low core loss according to the previous aspect, wherein the insulating film-coated soft magnetic powder is a phosphate film-coated soft magnetic powder.

The silicon resin film-coated soft magnetic powder with a thin silicon film having a thickness of from 0.1 μm to 5 μm on a surface of a general soft magnetic powder or insulating film-coated soft magnetic powder can be simply produced by adding 0.1-0.5 wt % or less of a liquid silicon resin to a commercially-available soft magnetic powder or insulating film-coated soft magnetic powder, mixing thereof by using a general method, and performing drying at the atmosphere. In the composite soft magnetic material produced by using the silicon resin film-coated soft magnetic powder with the thin silicon resin film having a thickness of from 0.1 μm to 5 μm on the surface thereof, an amount of the silicon resin contained therein can be in a range of from 0.1 wt % to 0.5 wt %.

Therefore, the silicon resin film-coated soft magnetic powder with a thin silicon resin film having a thickness of from 0.1 μm to 5 μm on a surface of phosphate film-coated soft magnetic powder having a phosphate film on the surface thereof can be simply produced by adding 0.1-0.5 wt % or less of a liquid silicon resin to a commercially-available phosphate film-coated soft magnetic powder having a phosphate film on a surface thereof, mixing thereof by using a general method, and performing drying at the atmosphere. In the composite soft magnetic material produced by using the silicon resin film-coated soft magnetic powder with the thin silicon resin film having a thickness of from 0.1 cm to 5 ((m on the surface thereof, an amount of the silicon resin contained therein can be in a range of from 0.1 wt % to 0.5 wt %.

### SUMMARY OF THE INVENTION

Since an amount of the silicon resin contained in the composite magnetic material can be further reduced, an amount of the soft magnetic powder or the phosphate film-coated soft magnetic powder can further increase, so that it is possible to manufacture a composite soft magnetic material capable of improving magnetic characteristics thereof and having a high strength and a low core loss which are the same as those of a conventional composite soft magnetic material.

The reason why the thickness of the silicon resin film formed on the surface of the silicon resin film-coated soft magnetic powder used in the method of manufacturing a composite soft magnetic material according to the present invention is set to in a range of from 0.1 ((m to 5 ((m is that, if the thickness of the silicon resin film is less than 0.1 ((m, sufficient strength and specific resistance cannot be secure, and if the thickness of the silicon resin film is more than 5 ((m, an amount of the silicon resin contained in the composite soft magnetic material is more than 0.5 wt %, so that sufficient soft magnetic characteristics can not be obtained.

The silicon resin film-coated soft magnetic powder is heated at a predetermined temperature of from the room temperature to 150 (C and, after that, filed in a mold which is heated at a temperature of from 100 (C to 150 (C and subject to compression molding. The reason why the mold is heated at the temperature of from 100 (C to 150 (C is that, when colloidal lubricant agent is coated on a wall surface of the mold, moisture contained in lubricant agent is evaporated and to attach the solid lubricant agent to the wall surface of the mold and increase molding density of the silicon resin film-coated soft magnetic powder. Accordingly, the heating temperature of the mold needs be 100 (C or more, but not 150 (C or more. When the heating temperature of the silicon resin film-coated soft magnetic powder filled in the heated mold is more than 150 (C, the soft magnetic powder is oxidized, so that the compression property does deteriorate. Therefore, even though the silicon resin film-coated soft magnetic powder filled in the mold is heated, it preferable that the heating temperature is suppressed within at most 150 (C.

The reason why the silicon resin film-coated soft magnetic powder filled in the mold is subject to compression molding at a pressure of from 600 Mpa to 1500 Mpa is that, if the compression molding pressure is less than 600 Mpa, it is difficult to obtain a sufficient density, and if the compression molding pressure is more than 1500 Mpa, the specific resistance is lowered or the strength of the mold is lowered, so that the size accuracy is severely lowered.

The compact obtained by compression molding is maintained in the atmosphere at a temperature of from 400° C. to 600° C. for a time of from 30 minutes to 60 minutes so as to be cured. By performing the curing at the temperature, the silicon resin is changed into a glass, so that a composite soft magnetic material having a high strength can be obtained. In addition, by performing the curing at the temperature, the deformation of the soft magnetic material is removed, so that the magnetic characteristics can be recovered. The reason why the curing temperature is limited to the temperature range of from 400° C. to 600° C. is that, if less than 400° C., it is not enough to remove the deformation occurring in the compression molding, and if more than 600° C., the specific resistance is lowered.

### DETAILED DESCRIPTION OF THE INVENTION

As a raw material, a phosphate film-coated soft magnetic powder is prepared by forming a phosphate film thereon by performing a phosphate treatment on pure iron powder, and a liquid silicon resin is prepared. By adding and mixing the liquid silicon resin to the phosphate film-coated soft magnetic powder with a ratio shown in Table 1 in the atmosphere, a silicon resin film-coated soft magnetic powder having a silicon resin film having an average thickness shown in Table 1 is produced.

TABLE 1

| | Composition of Raw Material (wt %) | | Average |
|---|---|---|---|
| | | phosphate film | Thickness of |
| | Silicon | coated soft | Silicon Resin |
| Type | Resin | magnetic powder | Film (μm) |
| Silicon Resin | 0.3 | balance | 2 |
| film coated | | | |
| soft magnetic | | | |
| powder | | | |

The silicon resin film-coated soft magnetic powder is heated at temperatures shown in Tables 2 and 3. The heated silicon resin film-coated soft magnetic powder is filled in a mold which is heat at temperatures shown in Tables 2 and 3 and subject to compressing molding with pressures shown in Tables 2 and 3 to produce a compact. Next, the compact is heated for a time shown in Tables 2 and 3 at temperatures shown in Tables 2 and 3 in the atmosphere, thereby performing methods 1 to 17 of the present invention and comparative methods 1 to 7. Accordingly, soft magnetic samples having a size of 5 mm (transverse width)×10 mm (longitudinal width)×60 mm (length) and soft magnetic samples having a size of 35 mm (outer diameter), 25 mm (inner diameter), and 5 mm (height). Transverse rupture strengths, densities, specific resistances, cores losses, and magnetic flux densities of the soft magnetic samples are measured at a room temperature, and the measured results are shown in Tables 2 and 3.

### CONVENTIONAL EXAMPLE 1

A mixture powder having a composition containing 5 wt % of a silicon resin powder and the balance composed of the phosphate film-coated soft magnetic powder is obtained by adding and mixing 5 wt % of a silicon resin powder to the phosphate film-coated soft magnetic powder prepared in the embodiment. The mixture powder is filled in a mold at the room temperature and subject to compression molding with a pressure of 700 MPa to produce a compact. The compact is heated at a temperature of 700° C. for a time of 120 minutes, thereby performing Conventional method 1. Accordingly, soft magnetic samples having a size of 5 mm (transverse width)×10 mm (longitudinal width)×60 mm (length) and soft magnetic samples having a size of 35 mm (outer diameter), 25 mm (inner diameter), and 5 mm (height). The transverse rupture strengths, densities, specific resistances, cores losses, and magnetic flux densities of the soft magnetic sample are measured at a room temperature, and the measured results are shown in Tables 2 and 3.

TABLE 2

| | | Production Conditions | | | | | | | | | |
|---|---|---|---|---|---|---|---|---|---|---|---|
| | | Heating | | | | | | | | | |
| | | Temperature Of | | | | Characteristics of Soft Magnetic Samples | | | | | |
| | | Silicon Resin | Heating | | | | | | | | Magnetic |
| | | Film Coated Soft | Temper- | Compression | | | Transverse | | Specific | | Flux |
| | | Magnetic Powder | ature | Molding | Curing | Curing | rupture | | Resistance × | Core | Density |
| | | of Table 1 | Of Mold | Pressure | Temp. | Time | strength | Density | 10⁻⁴ | Loss | B_{10000 A/m} |
| type | | (° C.) | (° C.) | (Mpa) | (° C.) | (Min.) | (Mpa) | (Mg/m [symbol] ) | (Ωm) | (W/Kg) | (T) |
| Mehod | 1 | 90 | 120 | 750 | 500 | 30 | 105 | 7.49 | 2.0 | 10.4 | 1.58 |
| of the | 2 | 60 | 120 | 800 | | | 100 | 7.49 | 2.8 | 10.5 | 1.58 |
| present | 3 | room temp. | 120 | 800 | | | 100 | 7.48 | 3.4 | 10.7 | 1.57 |
| invention | 4 | 150 | 150 | 800 | | | 110 | 7.48 | 3.0 | 10.8 | 1.57 |
| | 5 | 120 | 120 | 800 | | | 110 | 7.5 | 1.4 | 10.4 | 1.60 |
| | 6 | 100 | 120 | 800 | | | 105 | 7.49 | 2.5 | 10.5 | 1.58 |
| | 7 | 100 | 130 | 800 | | | 105 | 7.50 | 2.3 | 10.5 | 1.60 |
| | 8 | 100 | 140 | 800 | | | 105 | 7.52 | 1.8 | 10.3 | 1.61 |
| | 9 | 100 | 150 | 800 | | | 110 | 7.53 | 1.8 | 10.1 | 1.61 |
| | 10 | 100 | 120 | 1000 | | | 110 | 7.63 | 2.4 | 9.5 | 1.70 |
| | 11 | 100 | 120 | 1200 | | | 115 | 7.70 | 1.2 | 9.3 | 1.73 |
| | 12 | 100 | 120 | 630 | | | 95 | 7.34 | 4.7 | 13.8 | 1.45 |
| | 13 | 100 | 120 | 1500 | | | 115 | 7.74 | 0.88 | 9.3 | 1.75 |

TABLE 3

| | | Production Conditions | | | | | | | | | |
|---|---|---|---|---|---|---|---|---|---|---|---|
| | | Heating | | | | | | | | | |
| | | Temperature Of | | | | Characteristics of Soft Magnetic Samples | | | | | |
| | | Silicon Resin | Heating | | | | | | | | Magnetic |
| | | Film Coated Soft | Temper- | Compression | | | Transverse | | Specific | | Flux |
| | | Magnetic Powder | ature | Molding | Curing | Curing | rupture | | Resistance × | Core | Density |
| | | of Table 1 | Of Mold | Pressure | Temp. | Time | strength | Density | 10⁻⁴ | Loss | B_{10000 A/m} |
| type | | (° C.) | (° C.) | (Mpa) | (° C.) | (Min.) | (Mpa) | (Mg/m [symbol] ) | (Ωm) | (W/Kg) | (T) |
| Mehod of | 14 | 100 | 120 | 800 | 410 | 30 | 110 | 7.52 | 4.4 | 10.9 | 1.60 |
| the present | 15 | 100 | 120 | 800 | 450 | | 110 | 7.52 | 3.2 | 11.8 | 1.61 |
| invention | 16 | 100 | 120 | 800 | 550 | | 115 | 7.51 | 0.79 | 11.5 | 1.62 |
| | 17 | 100 | 120 | 800 | 580 | | 120 | 7.50 | 0.68 | 11.8 | 1.63 |
| Comparative | 1 | 165* | 120 | 800 | 500 | | 75 | 7.40 | 5.0 | 13.0 | 1.50 |
| Method | 2 | 100 | 160* | 800 | 500 | | 75 | 7.45 | 4.2 | 11.1 | 1.52 |
| | 3 | 100 | 90* | 800 | 500 | | 100 | 7.35 | 2.1 | 13.5 | 1.45 |
| | 4 | 100 | 120 | 1600* | 500 | | 120 | 7.75 | 0.11 | 13.1 | 1.75 |
| | 5 | 100 | 120 | 550* | 500 | | 85 | 7.23 | 3.8 | — | 1.41 |
| | 6 | 100 | 120 | 800 | 650* | | 120 | 7.50 | 0.0082 | 18.3 | 1.62 |
| | 7 | 100 | 120 | 800 | 350* | | 110 | 7.51 | 4.3 | 14.0 | 1.60 |

| | | | | | | | | | | |
|---|---|---|---|---|---|---|---|---|---|---|
| conventional Method 1 | — | 30 | 700 | 700 | 120 | 60 | 7.08 | 21 | — | 1.30 |

From the results shown in Tables 2 and 3, it can be seen that the soft magnetic samples produced by the methods 1 to 17 of the present invention have more excellent soft magnetic characteristics than those of the soft magnetic samples produced by Conventional method 1. In addition, it can be seen that some of the soft magnetic samples produced by comparative methods 1 to 7 do not have preferable characteristics.

As a raw material, a pure iron powder is prepared, and a liquid silicon resin is prepared. By adding and mixing the liquid silicon resin to the pure iron powder with a ratio shown in Table 4 in the atmosphere, a silicon resin film-coated soft magnetic powder having a silicon resin film having an average thickness shown in Table 4 is produced.

TABLE 4

| | Composition of Raw Material (wt %) | | Average |
|---|---|---|---|
| | | Phosphate Film | Thickness of |
| | Silicon | Coated Soft | Silicon Resin |
| Type | Resin | Magnetic Powder | Film (μm) |
| Silicon Resin | 0.3 | balance | 2 |
| film coated | | | |
| soft magnetic | | | |
| powder | | | |

The silicon resin film-coated soft magnetic powder of Table 4 is heated at temperatures shown in Tables 5 and 6. The heated silicon resin film-coated soft magnetic powder is filled in a mold which is heat at temperatures shown in Tables 5 and 6 and subject to compressing molding with pressures shown in Tables 5 and 6 to produce a compact. Next, the compact is heated for a time shown in Tables 5 and 6 at temperatures shown in Tables 5 and 6 in the atmosphere, thereby performing methods 18 to 27 of the present invention and comparative methods 8 to 13. Accordingly, soft magnetic samples having a size of 5 mm (transverse width)×10 mm (longitudinal width)×60 mm (length) and soft magnetic samples having a size of 35 mm (outer diameter), 25 mm (inner diameter), and 5 mm (height). The transverse rupture strengths, densities, specific resistances, cores losses, and magnetic flux densities of the soft magnetic samples are measured at a room temperature, and the measured results are shown in Tables 5 and 6.

### CONVENTION EXAMPLE 2

A mixture powder having a composition containing 5 wt % of a silicon resin powder and the balance composed of the phosphate film-coated soft magnetic powder is obtained by adding and mixing 5 wt % of a silicon resin powder to the pure iron powder prepared in the above embodiment. The mixture powder is filled in a mold at the room temperature and subject to compression molding with a pressure of 700 MPa to produce a compact. The compact is heated at a temperature of 700° C. for a time of 120 minutes, thereby performing Conventional method 2. Accordingly, soft magnetic samples having a size of 5 mm (transverse width)×10 mm (longitudinal width)×60 mm (length) and soft magnetic samples having a size of 35 mm (outer diameter), 25 mm (inner diameter), and 5 mm (height). The transverse rupture strengths, densities, specific resistances, cores losses, and magnetic flux densities of the soft magnetic sample are measured at a room temperature, and the measured results are shown in Table 6.

TABLE 5

| | | Production Conditions | | | | | | | | | |
|---|---|---|---|---|---|---|---|---|---|---|---|
| | | Heating | | | | | | | | | |
| | | Temperature Of | | | | Characteristics of Soft Magnetic Samples | | | | | |
| | | Silicon Resin | Heating | | | | | | | | Magnetic |
| | | Film Coated Soft | Temper- | Compression | | | Transverse | | Specific | | Flux |
| | | Magnetic Powder | ature | Molding | Curing | Curing | rupture | | Resistance × | Core | Density |
| | | of Table 4 | Of Mold | Pressure | Temp. | Time | strength | Density | 10 − 4 | Loss | B_{10000 A/m} |
| type | | (° C.) | (° C.) | (Mpa) | (° C.) | (Min.) | (Mpa) | (Mg/m [symbol] ) | (Ωm) | (W/Kg) | (T) |
| Mehod | 18 | room temp. | 120 | 800 | 500 | 30 | 110 | 7.51 | 1.2 | 10.4 | 1.58 |
| of the | 19 | 100 | 120 | 800 | | | 113 | 7.51 | 0.92 | 10.5 | 1.58 |
| present | 20 | 100 | 120 | 800 | | | 120 | 7.53 | 0.98 | 10.7 | 1.57 |
| invention | 21 | 100 | 120 | 650 | | | 107 | 7.40 | 1.5 | 10.8 | 1.57 |
| | 22 | 100 | 120 | 1100 | | | 123 | 7.66 | 0.78 | 10.4 | 1.60 |
| | 23 | 100 | 120 | 1500 | | | 125 | 7.75 | 0.53 | 10.5 | 1.58 |
| | 24 | 100 | 100 | 800 | | | 121 | 7.51 | 0.37 | 10.5 | 1.60 |
| | 25 | 100 | 150 | 800 | | | 125 | 7.53 | 0.85 | 10.3 | 1.61 |
| | 26 | 120 | 120 | 800 | | | 120 | 7.52 | 0.89 | 10.1 | 1.61 |
| | 27 | 150 | 120 | 800 | | | 126 | 7.53 | 0.82 | 9.5 | 1.70 |

TABLE 6

| | | Production Conditions | | | | | | | | | |
|---|---|---|---|---|---|---|---|---|---|---|---|
| | | Heating | | | | | | | | | |
| | | Temperature Of | | | | Characteristics of Soft Magnetic Samples | | | | | |
| | | Silicon Resin | Heating | | | | | | | | Magnetic |
| | | Film Coated Soft | Temper- | Compression | | | Transverse | | Specific | | Flux |
| | | Magnetic Powder | ature | Molding | Curing | Curing | rupture | | Resistance × | Core | Density |
| | | of Table 4 | Of Mold | Pressure | Temp. | Time | strength | Density | 10⁻⁴ | Loss | B_{10000 A/m} |
| type | | (° C.) | (° C.) | (Mpa) | (° C.) | (Min.) | (Mpa) | (Mg/m [symbol] ) | (Ωm) | (W/Kg) | (T) |
| Comparative | 8 | 160* | 120 | 800 | 500 | 30 | 72 | 7.41 | 5.1 | 12.1 | 1.51 |
| Method | 9 | 100 | 90* | 800 | 500 | | 83 | 7.34 | 1.6 | 13.4 | 1.47 |
| | 10 | 100 | 120 | 1650* | 500 | | 127 | 7.77 | 0.23 | 14.2 | 1.76 |
| | 11 | 100 | 120 | 570* | 500 | | 120 | 7.29 | 1.7 | — | 1.42 |
| | 11 | 100 | 120 | 800 | 500 | | 85 | 7.51 | 0.0069 | 17.9 | 1.61 |
| | 13 | 100 | 120 | 800 | 650 | | 124 | 7.53 | 1.3 | 14.8 | 1.60 |

| | | | | | | | | | | |
|---|---|---|---|---|---|---|---|---|---|---|
| Conventional | — | 30 | 700 | 700 | 120 | 65 | 7.1 | 21 | — | 1.32 |
| Method 2 | | | | | | | | | | |

From the results shown in Tables 5 and 6, it can be seen that the soft magnetic samples produced by the methods 17 to 27 of the present invention have more excellent soft magnetic characteristics than those of the soft magnetic samples produced by Conventional method 2. In addition, it can be seen that some of the soft magnetic samples produced by comparative methods 8 to 13 do not have preferable characteristics.

1: A method of manufacturing a composite soft magnetic material having excellent magnetic characteristics, a high strength, and a low core loss, comprising steps of:
heating a silicon resin film-coated soft magnetic powder at a temperature of from the room temperature to 150° C. obtained by forming a thin silicon resin film having a thickness of from 0.1 μm to 5 μm on a surface of a soft magnetic powder or an insulating film-coated soft magnetic powder;
filling the silicon resin film-coated soft magnetic powder heated at a temperature of from the room temperature to 150° C. in a mold which is heated at a temperature of from 100° C. to 150° C. and performing compaction at a pressure of from 600 MPa to 1500 MPa, thereby obtaining a compact; and
curing the compact at a temperature of from 400° C. to 600° C.

2: The method of manufacturing the composite soft magnetic material having excellent magnetic characteristics, a high strength, and a low core loss according to claim 1, wherein the insulating film-coated soft magnetic powder is a phosphate film-coated soft magnetic powder.

3: A composite soft magnetic material having excellent magnetic characteristics, a high strength, and a low core loss manufactured according to claim 1.

4: A composite soft magnetic material having excellent magnetic characteristics, a high strength, and a low core loss manufactured according to claim 2.
